(19) United States
(12) Patent Application Publication
(10) Pub. No.: US 2026/0340147 A1
(43) Pub. Date: Oct. 29, 2026

(54) VULNERABILITY THREAT EVALUATION SYSTEM AND METHOD

(71) Applicant: Hitachi, Ltd., Tokyo (JP)

(72) Inventors: Yoshiyuki FUJIMOTO, Tokyo (JP); Suzuka UEDA, Tokyo (JP)

(21) Appl. No.: 19/542,160

(22) Filed: Feb. 17, 2026

(30) Foreign Application Priority Data
Apr. 25, 2025 (JP) 2025-073213

(51) Int. Cl. G06F 21/57

(52) U.S. Cl. CPC G06F 21/577

(57) ABSTRACT

A vulnerability threat evaluation system: stores, in advance, resource information indicating resources where software exists in an evaluation target and security information indicating information related to restrictions on access to resources in the evaluation target; acquires vulnerability information; based on the vulnerability information and the resource information, specifies target software having a vulnerability and a target resource in which the target software is present in the evaluation target; based on information of the target resource and the security information, calculates a security parameter that is a parameter specific to the evaluation target and determined according to access restrictions; based on information of the target software, calculates a common parameter indicating a degree to which a threat posed by a vulnerability affects the evaluation target independent of the evaluation target; and based on the security parameter and the common parameter, calculates a threat level of a vulnerability of the evaluation target.

### CROSS-REFERENCE TO RELATED APPLICATIONS

This application is based upon and claims the benefit of priority from Japanese Patent Application No. 2025-073213 filed in Japan Patent Office on Apr. 25, 2025, the contents of which are hereby incorporated by reference.

The present disclosure relates to a technique for evaluating a vulnerability threat.

### BACKGROUND

Evaluations of vulnerabilities in information systems and infrastructure are performed. Japanese Patent Application Publication No. 2020-194344 discloses a processing apparatus and a processing method that enable, when open-source software is used, handling of vulnerable open-source software to be appropriately determined. In Japanese Patent Application Publication No. 2020-194344, the processing apparatus that determines a vulnerability of open-source software is equipped with a control unit that outputs a priority of vulnerability based on at least one of first information indicating whether or not the open-source software is externally accessible and second information indicating whether or not an attack code targeting a vulnerability in the open-source software is being circulated. The control unit configures a priority of a vulnerability present in externally accessible open-source software higher than a vulnerability present in open-source software that is not externally accessible and configures a priority of a vulnerability for which an attack code is being circulated higher than a vulnerability for which an attack code is not being circulated.

### SUMMARY

In the method according to Japanese Patent Application Publication No. 2020-194344, for a system including open-source software, a user interface prompts a user to input whether or not the open-source software is externally accessible, and for a vulnerability present in externally accessible open-source software, a higher priority is configured as compared to a vulnerability present in open-source software that is not externally accessible.

Software with Internet connectivity may be subjected to IP restrictions. Even if a vulnerability is present in externally accessible software, the vulnerability may remain undetected if IP restrictions are in place that permit or deny access only from specific IP addresses.

While the method according to Japanese Patent Application Publication No. 2020-194344 takes into consideration whether or not external access is possible, since the so-called “accessibility” referred to in the method simply means whether or not a network interface connecting to the outside is present, for example, there is no difference in evaluated threat severity between a case where a vulnerability is less likely to be detected due to IP restrictions and a case where a vulnerability is likely to be detected. Priorities determined in this manner may not be able to adequately evaluate the severity of threat posed by a vulnerability. An object included in the present disclosure is to provide a technique that enables a severity of threat posed by a vulnerability to be appropriately evaluated.

A vulnerability threat evaluation system according to an aspect included in the present disclosure is a vulnerability threat evaluation system that evaluates a threat posed by a vulnerability of an evaluation target constituted of resources and software, the vulnerability threat evaluation system including: a storage apparatus and a processor, wherein the storage apparatus is configured to store, in advance: resource information indicating resources where software exists in the evaluation target; and security information indicating information related to restrictions on access to resources in the evaluation target, and the processor is configured to: acquire vulnerability information that is information regarding a vulnerability present in software; based on the vulnerability information and the resource information, specify target software having a vulnerability and a target resource in which the target software is present in the evaluation target; based on information of the target resource and the security information, calculate a security parameter that is a parameter specific to the evaluation target and determined according to the restrictions on access to the target resource in the evaluation target; based on information of the target software, calculate a common parameter indicating a degree to which a threat posed by a vulnerability affects the evaluation target independent of the evaluation target; and based on the security parameter and the common parameter, calculate a threat level indicating a severity of a threat posed by a vulnerability of the evaluation target.

According to an aspect included in the present disclosure, a severity of threat posed by a vulnerability can be appropriately evaluated.

### BRIEF DESCRIPTION OF THE DRAWINGS

FIG. 1 is a block diagram showing a configuration of a vulnerability threat evaluation system;

FIG. 2 is a diagram showing a hardware configuration of a computer;

FIG. 3 is a diagram showing a table structure of resource information;

FIG. 4 is a diagram showing a table structure of network information;

FIG. 5 is a diagram showing a table structure of infrastructure user information;

FIG. 6 is a diagram showing a table structure of security information;

FIG. 7 is a diagram showing a table structure of infrastructure design information;

FIG. 8 is a flow chart showing overall processing; and

FIG. 9 is a flow chart showing details of infrastructure-specific processing.

### DETAILED DESCRIPTION OF THE EMBODIMENT

An embodiment of the present invention will be described with reference to the drawings.

The present embodiment exemplifies a vulnerability threat evaluation system which collaborates with a platform that provides a plurality of operators with infrastructure of an information processing system operated by each operator and which evaluates a threat posed by a vulnerability for each infrastructure provided by the platform.

The infrastructure which is provided by the platform and which constitutes an evaluation target of the vulnerability threat evaluation system according to the present embodiment is constituted of resources and software. Resources are the various devices that make up the infrastructure, such as servers, routers, load balancers, storages, and firewalls. Software includes software made open to the public that is known as OSS (Open-Source Software). Information regarding vulnerabilities in open-source software is generally available through various vulnerability information databases. Hereinafter, information related to the vulnerability of software that can be obtained from vulnerability information databases will also be referred to as vulnerability information.

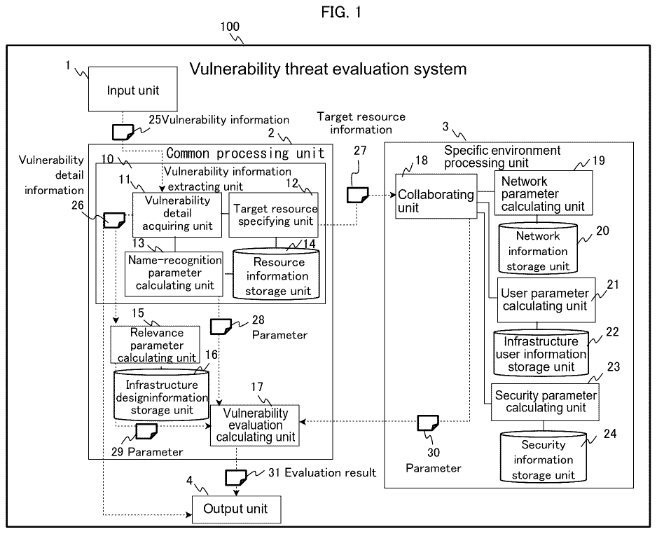

FIG. 1 is a block diagram showing a configuration of a vulnerability threat evaluation system according to the present embodiment.

Referring to FIG. 1, a vulnerability threat evaluation system 100 includes an input unit 1, a common processing unit 2, a specific environment processing unit 3, and an output unit 4 as main components. The common processing unit 2 and the specific environment processing unit 3 collaborate with each other to realize evaluation of a threat posed by a vulnerability for each infrastructure. The common processing unit 2 is a functional unit that primarily performs processing common to a plurality of infrastructures. The specific environment processing unit 3 is a functional unit that primarily performs processing specific to each infrastructure.

In order to evaluate a vulnerability, the vulnerability threat evaluation system 100 first acquires vulnerability information 25 in the input unit 1 and gives the vulnerability information 25 to the common processing unit 2. The vulnerability information 25 is information including details of a vulnerability present in software.

The common processing unit 2 includes a vulnerability information extracting unit 10, a relevance parameter calculating unit 15, an infrastructure design information storage unit 16, and a vulnerability evaluation calculating unit 17. The vulnerability information extracting unit 10 includes a vulnerability detail acquiring unit 11, a target resource specifying unit 12, a name-recognition parameter calculating unit 13, and a resource information storage unit 14.

The vulnerability detail acquiring unit 11 acquires detailed information (vulnerability detail information 26) related to a vulnerability from the vulnerability information 25 and gives the detailed information to the relevance parameter calculating unit 15 and the output unit 4.

The resource information storage unit 14 stores resource information indicating resources in which each software is present and name recognition of each software.

The target resource specifying unit 12 refers to resource information, specifies a resource (target resource) in which software (target software) that is a target of vulnerability indicated in the vulnerability information 25 is present, and provides target resource information 27 to the specific environment processing unit 3.

The name-recognition parameter calculating unit 13 refers to resource information to specify name recognition of the target software and, based on the name recognition, specifies a name-recognition parameter 28 to calculate a threat level of a vulnerability. The threat level of a vulnerability is an indicator that indicates a severity of a threat posed by the vulnerability with respect to the infrastructure. The name-recognition parameter 28 is one of the common parameters that indicate a degree to which the threat posed by the vulnerability affects each infrastructure independent of the infrastructure.

The infrastructure design information storage unit 16 stores information (infrastructure design information) related to the design of infrastructure. For example, the infrastructure design information is information described in the design documents of the infrastructure. The fundamental design of infrastructure is common to all infrastructures, and the infrastructure design document is a design document that outlines the common design independent of specific infrastructures.

The relevance parameter calculating unit 15 calculates, based on infrastructure design information and vulnerability detail information 26, a relevance parameter 29 indicating a similarity between infrastructure and target software. The relevance parameter 29 is one of the common parameters that indicate a degree to which the threat posed by the vulnerability affects each infrastructure independent of the infrastructure.

The vulnerability evaluation calculating unit 17 integrates the name-recognition parameter 28 and the relevance parameter 29 which are common parameters and each infrastructure-specific parameter to be described later, calculates a final threat level of a vulnerability with respect to infrastructure, and gives an evaluation result 31 based on the threat level to the output unit 4.

The specific environment processing unit 3 includes a collaborating unit 18, a network parameter calculating unit 19, a network information storage unit 20, a user parameter calculating unit 21, an infrastructure user information storage unit 22, a security parameter calculating unit 23, and a security information storage unit 24.

The collaborating unit 18 acquires the target resource information 27 from the common processing unit 2, supplies the target resource information 27 to the network parameter calculating unit 19, the user parameter calculating unit 21, and the security parameter calculating unit 23, acquires each specific parameter 30 calculated by the network parameter calculating unit 19, the user parameter calculating unit 21, and the security parameter calculating unit 23, and gives each security parameter 30 to the common processing unit 2. The network information storage unit 20 stores network information indicating a connection configuration of resources in the infrastructure.

The network parameter calculating unit 19 calculates a network parameter determined for the target resource based on the network information and according to the connection configuration of the resources in the infrastructure. The network parameter is a parameter for calculating the threat level of a vulnerability with respect to the infrastructure and is a specific parameter that is specific to the infrastructure.

The infrastructure user information storage unit 22 stores infrastructure user information that is information related to users of the infrastructure.

The user parameter calculating unit 21 calculates, based on the infrastructure user information, a user parameter for calculating a threat level of a vulnerability with respect to the infrastructure that is determined according to users of the infrastructure. The user parameter is a parameter specific to the infrastructure.

The security information storage unit 24 stores security information that is information related to restrictions on access to resources in the infrastructure.

The security parameter calculating unit 23 calculates, based on the security information, a security parameter for calculating a threat level of a vulnerability with respect to the infrastructure that is determined according to restrictions on access to the target resource in the infrastructure. The security parameter is a parameter specific to the infrastructure.

The output unit 4 outputs output information based on the evaluation result 31 from the vulnerability evaluation calculating unit 17. The output clearly indicates the severity of a vulnerability and the urgency of response to system administrators and relevant parties.

As described above, according to the vulnerability threat evaluation system 100 of the present embodiment, since a threat level of a vulnerability of the infrastructure is calculated by integrating common parameters (name-recognition parameter, relevance parameter) calculated uniformly across infrastructures and specific parameters (security parameter, user parameter, network parameter) calculated specifically for each infrastructure, an impact of the vulnerability can be evaluated from a more precise and multifaceted perspective, rather than simply evaluating the feasibility of external access.

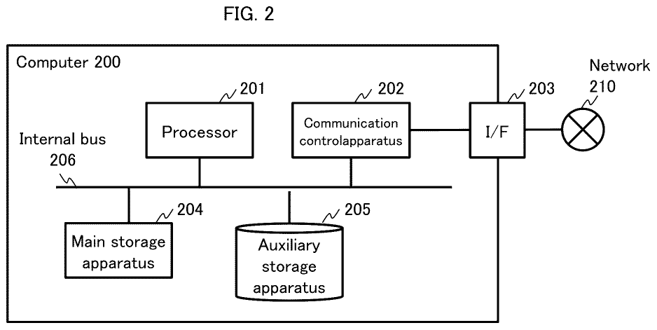

FIG. 2 is a diagram showing a hardware configuration of a computer that realizes the vulnerability threat evaluation system according to the present embodiment.

The computer 200 includes a processor 201, a communication control apparatus 202, an external interface 203, a main storage apparatus 204, and an auxiliary storage apparatus 205 which are connected to one another via an internal bus 206.

The processor 201 is a computational processing unit such as a CPU, and by executing software programs stored in the main storage apparatus 204 or the auxiliary storage apparatus 205, the processor 201 functions as each unit (input unit 1, common processing unit 2, specific environment processing unit 3, and output unit 4) of the vulnerability threat evaluation system 100 according to the present embodiment.

The main storage apparatus 204 is a volatile memory such as a RAM (Random Access Memory), and temporarily stores programs executed by the processor 201 together with data necessary for processing.

The auxiliary storage apparatus 205 is a non-volatile memory such as an HDD (Hard Disk Drive), an SSD (Solid State Drive), or a ROM (Read Only Memory), and stores programs and various data semi-permanently. In particular, in the present embodiment, programs for realizing the vulnerability threat evaluation system 100, resource information, infrastructure design information, network information, infrastructure user information, security information, various parameters, information on threat levels, and the like are stored in the auxiliary storage apparatus 205.

The communication control apparatus 202 is an apparatus that controls communication with other apparatuses via a network 210 and is used when, for example, acquiring vulnerability information 25 from a vulnerability information database (not illustrated).

The external interface 203 is an interface for connecting to the network 210.

An input apparatus such as a keyboard, a mouse, or a touch panel to be operated by a user may be connected to the computer 200. In addition, a display apparatus that displays images and texts such as a liquid crystal display may be connected to the computer 200.

The vulnerability threat evaluation system 100 according to the present embodiment is realized by the hardware configuration described above. Note that the vulnerability threat evaluation system 100 is not limited to being configured as an integrated computer 200 such as that shown in FIG. 2 and may be realized as a distributed system in which a plurality of computers run collaboratively. In addition, the vulnerability threat evaluation system 100 may be constructed on the cloud.

Hereinafter, detailed operations of the vulnerability threat evaluation system according to the present embodiment will be described.

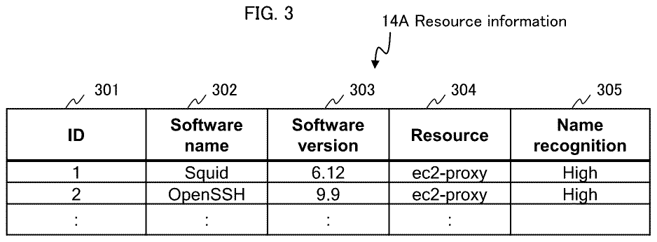

FIG. 3 is a diagram showing a table structure of resource information. The table serves as a reference source for the system when evaluating a vulnerability.

Resource information 14A is constituted of five columns: ID 301, software name 302, software version 303, resource 304, and name recognition 305. Specifically, FIG. 3 shows information of software named Squid and OpenSSH.

Details of each column are as follows. ID 301 indicates an identifier uniquely assigned to each software. Software name 302 contains the names of software such as Squid and OpenSSH. Software version 303 stores version information of each software (for example, 6.12 for Squid and 9.9 for Open SSH). Resource 304 indicates a resource in which the software is present (in this example, ec2-proxy). Name recognition 305 records name recognition of the software (in this example, “High” that means name recognition is high). The name recognition of software may be set in advance by an administrator. The administrator may also periodically review and update the name recognition of software.

The resource information 14A is utilized by the name-recognition parameter calculating unit 13 in the common processing unit 2 and used to evaluate the threat posed by a vulnerability while taking the name recognition of software into consideration. Specifically, the name recognition is reflected on the name-recognition parameter such that the threat level of a vulnerability of infrastructure using software with high name recognition is given a high value.

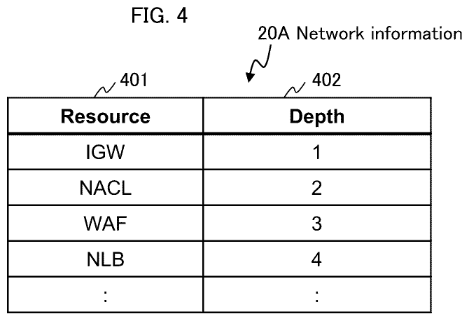

FIG. 4 is a diagram showing a table structure of network information. The table is used when evaluating a structure of a network in the infrastructure.

Network information 20A is constituted of two columns: resource 401 and depth 402. The network information 20A is used to calculate a network parameter in the network parameter calculating unit 19 of the specific environment processing unit 3.

Resource 401 lists the various resources that constitute the infrastructure (IGW, NACL, WAF, NLB, and the like). Depth 402 indicates a depth of a network layer for each resource. Depth 402 corresponds to the number of resources that external data communication traverses before reaching a target resource. For example, IGW (Internet gateway) has a depth of 1. NACL has a depth of 2. WAF has a depth of 3. NLB (network load balancer) has a depth of 4. Depth 402 is used when calculating the threat level of a vulnerability. Generally, since the greater the depth, the more difficult it becomes for external attacks to directly reach the target resource, a lower threat level is evaluated for the vulnerability.

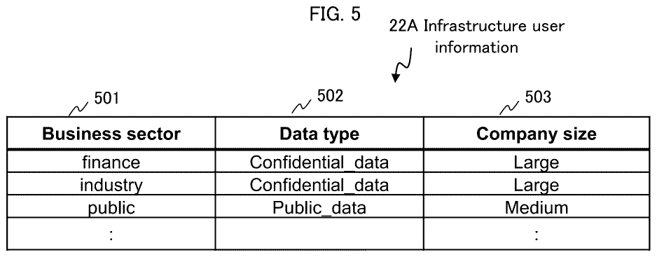

FIG. 5 is a diagram showing a table structure of infrastructure user information. The table is used when evaluating users of the infrastructure.

Infrastructure user information 22A shown in FIG. 5 is constituted of three columns: business sector 501, data type 502, and company size 503. Business sector 501 contains business sectors of users who use the infrastructure. For example, business sectors include industries such as finance, manufacturing (industry), and public utilities (public). Data type 502 contains types of data handled in the infrastructure. Examples of data types include confidential data and public data. Company size 503 contains company sizes of users who use the infrastructure. Examples of company sizes include large scale (large) and medium scale (medium).

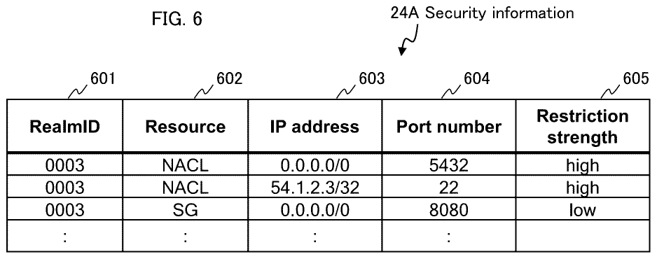

FIG. 6 is a diagram showing a table structure of security information. Security information 24A contains information for calculating security parameters.

The security information 24A shown in FIG. 6 is constituted of five columns: Realm ID 601, resource 602, IP address 603, port number 604, and restriction strength 605. Specifically, information related to NACL and SG that are resources with Realm IDs of 0003 is shown.

Realm ID 601 contains identification information that uniquely identifies the user consuming the resource. Resource 602 contains a name of a resource related to network security such as NACL and SG. IP address 603 contains a specific IP address such as 0.0.0.0/0 or a specific IP address range. Port number 604 contains a specific port number such as 5432 or 8080. Restriction strength 605 contains a restriction level in the security configuration of each resource. The stronger the restrictions, the lower the threat level of the vulnerability is evaluated.

The security information 24A is used in the security parameter calculating unit 23 to analyze details of access restrictions to the target resource. Specifically, a security parameter that is specific to each infrastructure is calculated while taking into consideration the IP address restriction range, permitted ports, and restriction strength.

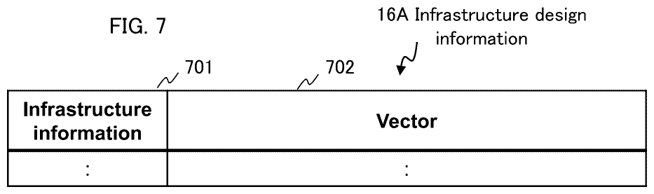

FIG. 7 is a diagram showing a table structure of infrastructure design information. The infrastructure design information contains common design details that are independent of individual infrastructures. The infrastructure design information is used when evaluating a similarity between vulnerability target software and infrastructure.

Infrastructure design information 16A shown in FIG. 7 is constituted of two columns: infrastructure information 701 and vector 702.

Infrastructure information 701 contains information related to the design of the infrastructure. Vector 702 contains information related to the design of the infrastructure expressed as a vector. By similarly converting the vulnerability detail information 26 in the vulnerability information 25 into a vector representation, a similarity between the vulnerability information and the infrastructure design can be calculated based on a distance between the vectors. The relevance parameter is calculated based on similarity. The higher the similarity, the higher the relevance parameter is evaluated.

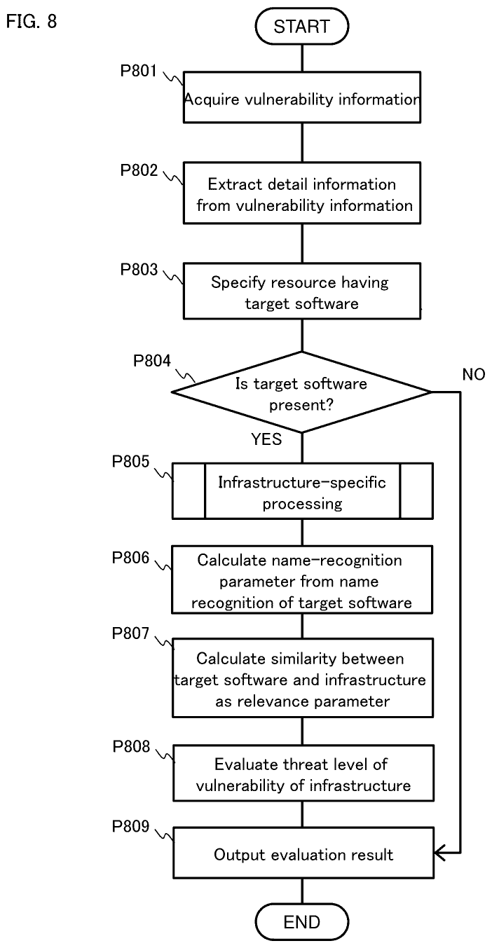

FIG. 8 is a flow chart showing overall processing.

First, in step P801, the vulnerability detail acquiring unit 11 of the common processing unit 2 acquires vulnerability information 25 via the input unit 1. The vulnerability information 25 includes information regarding potential vulnerabilities present in software. Next, in step P802, the vulnerability detail acquiring unit 11 extracts vulnerability detail information 26 from the acquired vulnerability information 25. The vulnerability detail information 26 is a portion that describes the vulnerability in detail in the vulnerability information 25. The vulnerability detail information 26 is to be used in subsequent processing.

In step P803, the target resource specifying unit 12 refers to the resource information 14A, selects software with a vulnerability among software used in the infrastructure that is an evaluation target provided by a platform as target software, selects a resource in the infrastructure in which the target software is present as a target resource, and specifies both the target software and the target resource. For example, when the vulnerability information indicates that version 6.12 of the software named Squid shown in the resource information 14A in FIG. 3 is a target of vulnerability, the software is the target software and the resource named ec2-proxy where the software is present is the target resource.

The specified target resource is a component of the infrastructure that may be affected by the vulnerability. The target resource specifying unit 12 gives target resource information 27 indicating the specified target resource to the specific environment processing unit 3.

In addition, in step P804, the target resource specifying unit 12 determines whether or not the target software is present in the infrastructure. When the target software is not present, since the infrastructure is not affected by vulnerabilities, the processing is terminated. On the other hand, when the target software is present, the processing advances to step P805.

In step P805, the specific environment processing unit 3 executes infrastructure-specific processing. The infrastructure-specific processing is processing specific to the environment of the infrastructure in which the target software runs. While details of the infrastructure-specific processing will be provided later, the infrastructure-specific processing generates a network parameter, a user parameter, and a security parameter as specific parameters 30 that are specific to the environment of the infrastructure. The specific parameter 30 is given to the vulnerability evaluation calculating unit 17.

Next, in step P806, in the common processing unit 2, the name-recognition parameter calculating unit 13 calculates the name-recognition parameter 28 from the name recognition of the target software. The name recognition of the target software is obtained by referring to the resource information 14A illustrated in FIG. 3. For example, the name recognition of version 6.12 of the software named Squid shown in the resource information 14A in FIG. 3 is high. The name-recognition parameter 28 calculated by the name-recognition parameter calculating unit 13 is given to the vulnerability evaluation calculating unit 17.

Furthermore, in step P807, the relevance parameter calculating unit 15 refers to the infrastructure design information 16A and calculates a similarity between the target software and the infrastructure as the relevance parameter 29. For example, the relevance parameter calculating unit 15 expresses the vulnerability detail information 26 of the target software by a vector (first vector) and calculates an inter-vector distance from a vector (second vector) that represents the infrastructure design information 16A. A cosine distance or a Euclidean distance can be used as the inter-vector distance. The shorter the distance, the higher the similarity between the target software and the infrastructure. The similarity may be adopted as the relevance parameter 29. The relevance parameter 29 serves as an indicator for evaluating the extent to which a vulnerability impacts the infrastructure. The higher the relevance parameter 29 that represents similarity, the greater the threat level of the vulnerability. The relevance parameter 29 is given to the vulnerability evaluation calculating unit 17.

In step P808, the vulnerability evaluation calculating unit 17 calculates the threat level of the vulnerability of the infrastructure based on the name-recognition parameter 28 and the relevance parameter 29 which are common parameters and the network parameter, the user parameter, and the security parameter which are specific parameters 30, and further generates an evaluation result 31 based on the threat level. For example, each of the name-recognition parameter 28, the relevance parameter 29, the network parameter, the user parameter, and the security parameter may be weighted, and a sum of the weighted values may be adopted as the threat level. The weight of each parameter may be determined as appropriate, taking into consideration points emphasized in a system policy. In addition, for example, two thresholds, namely, a first threshold and a second threshold (first threshold>second threshold) may be set, and a response policy may be displayed in which a “urgent response” is required if threat level≥first threshold, a “response by monthly maintenance” is required if first threshold>threat level≥second threshold, and “not required” if second threshold>threat level.

Finally, in step P809, the output unit 4 outputs the evaluation result 31 based on the threat level and the vulnerability detail information. Accordingly, information for analyzing the impact of the vulnerability and devising an appropriate countermeasure can be provided. The output of the evaluation result 31 and the vulnerability detail information may involve, for example, displaying information related to the threat posed by the vulnerability with respect to the infrastructure on a management screen or notifying the information to users of the infrastructure of which the threat level was equal to or higher than a predetermined threshold.

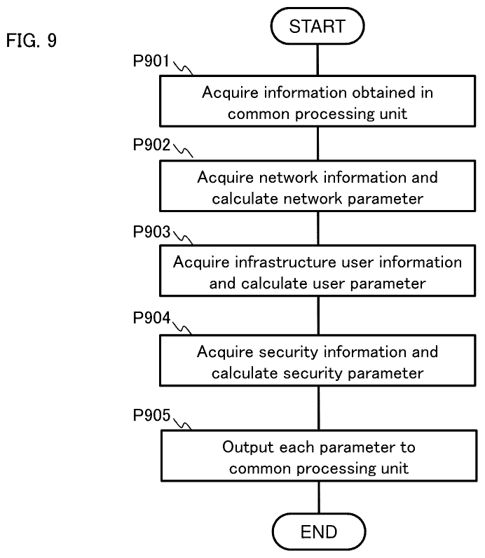

FIG. 9 is a flow chart showing details of infrastructure-specific processing.

First, in step P901, in the specific environment processing unit 3, the collaborating unit 18 acquires the target resource information 27 obtained by the common processing unit 2. The target resource information 27 indicates in which resource among the resources constituting the infrastructure is the software that is a target of vulnerability present. The target resource information 27 is delivered to the network parameter calculating unit 19, the user parameter calculating unit 21, and the security parameter calculating unit 23.

Next, in step P902, the network parameter calculating unit 19 acquires network information 20A, and based on the network information 20A and the target resource information 27, calculates a network parameter which is a parameter specific to the infrastructure and which is determined for the target resource according to the connection configuration of the resources in the infrastructure. Specifically, a network parameter is calculated such that the threat level is lower when data communication from outside the infrastructure traverses a greater number of resources before reaching the target resource, and the threat level is lower when it traverses fewer resources. For example, in the network information 20A illustrated in FIG. 4, if IGW is the target resource, the value of the network parameter increases since the depth of IGW is shallow at 1. On the other hand, if NLB is the target resource, the value of the network parameter decreases since the depth of NLB is deep at 4. As an example, when depth=n, the network parameter may be 1/n.

In step P903, the user parameter calculating unit 21 acquires infrastructure user information 22A, and based on the infrastructure user information 22A and the target resource information 27, calculates a user parameter which is a parameter specific to the infrastructure and which is determined according to a user of the infrastructure.

Specifically, the user parameter is calculated such that, when the target resource is present in the infrastructure, a magnitude of the threat level changes according to a magnitude of the impact when a failure occurs in the business of the user of the infrastructure according to attributes of the user.

For example, a value according to the magnitude of impact is to be set in advance for each of the business sector 501 of the user, the data type 502 of data handled by the user, and the company size 503 of the user in the infrastructure user information 22A illustrated in FIG. 5. For business sector 501, a largest value may be set to finance, a next largest value may be set to manufacturing (industry), and a next largest value may be set to public utilities (public). For data type 502, a largest value may be set to confidential data and a next largest value may be set to public data. For company size 503, a largest value may be set to large companies (large) and a next largest value may be set to medium companies (medium). In addition, a value obtained by multiplying the three values of business sector 501, data type 502, and company size 503 that correspond to the user of the infrastructure may be calculated as the user parameter.

In step P904, the security parameter calculating unit 23 acquires security information 24A, and based on the security information 24A and the target resource information 27, calculates a security parameter which is a parameter specific to the infrastructure and which is determined according to restrictions on access to the target resource in the infrastructure.

Specifically, a security parameter is calculated such that if restriction strength 605 of the target resource is high, the threat level is low, and if restriction strength 605 is low, the threat level is high. For example, in the security information 24A illustrated in FIG. 6, a high restriction is applied to a port with a port number of 22 and an IP address of 54.1.2.3/32 of a resource called NACL and a low restriction is applied to a port with a port number of 8080 and an IP address of 0.0.0.0/0 of a resource called SG. Therefore, the security parameter when NACL is the target resource has a larger value than the security parameter when SG is the target resource.

Finally, in step P905, the collaborating unit 18 outputs the network parameter, the user parameter, and the security parameter to the common processing unit 2.

The present embodiment described above is simply an example to illustrate the present invention and is not intended to limit the scope of the present invention to the embodiment. Those skilled in the art can implement the present invention in various other forms without departing from the spirit or scope of the present invention.

In addition, the embodiment described above includes the following items. However, items included in the embodiment are not limited to those described below.

### Item 1

A vulnerability threat evaluation system that evaluates a threat posed by a vulnerability of an evaluation target constituted of resources and software, the vulnerability threat evaluation system including: a storage apparatus and a processor, wherein the storage apparatus is configured to store, in advance: resource information indicating resources where software exists in the evaluation target; and security information indicating information related to restrictions on access to resources in the evaluation target, and the processor is configured to: acquire vulnerability information that is information regarding a vulnerability present in software; based on the vulnerability information and the resource information, specify target software having a vulnerability and a target resource in which the target software is present in the evaluation target; based on information of the target resource and the security information, calculate a security parameter that is a parameter specific to the evaluation target and determined according to the restrictions on access to the target resource in the evaluation target; based on information of the target software, calculate a common parameter indicating a degree to which a threat posed by a vulnerability affects the evaluation target independent of the evaluation target; and based on the security parameter and the common parameter, calculate a threat level indicating a severity of a threat posed by a vulnerability of the evaluation target. Accordingly, a severity of threat posed by a vulnerability can be appropriately evaluated.

### Item 2

In the vulnerability threat evaluation system according to the item described above, the evaluation target is an infrastructure of an information system. Accordingly, a vulnerability threat of an infrastructure system can be appropriately evaluated.

### Item 3

In the vulnerability threat evaluation system according to the item described above, the storage apparatus is configured to further store in advance user information that is information related to a user of the evaluation target, and the processor is configured to calculate, based on the user information, a user parameter which is a parameter specific to the evaluation target and which is determined according to the user of the evaluation target and to calculate the threat level based on the security parameter, the common parameter, and the user parameter. Accordingly, a vulnerability threat of the evaluation target can be evaluated by taking into consideration a user of the evaluation target.

### Item 4

In the vulnerability threat evaluation system according to the item described above, the storage apparatus is configured to store in advance network information indicating a connection configuration of resources in the evaluation target, and the processor is configured to calculate, based on the network information, a network parameter which is a parameter specific to the evaluation target and which is determined for the target resource according to the connection configuration of resources in the evaluation target and to calculate the threat level based on the security parameter, the common parameter, and the network parameter. Accordingly, a vulnerability threat of the evaluation target can be evaluated by taking into consideration a network of the evaluation target.

### Item 5

In the vulnerability threat evaluation system according to the item described above, the processor is configured to determine the network parameter based on a depth corresponding to the number of resources traversed by data communication from outside the evaluation target before reaching the target resource. Accordingly, a vulnerability threat of the evaluation target can be evaluated by taking into consideration an arrangement of the target resource in the evaluation target.

### Item 6

In the vulnerability threat evaluation system according to the item described above, the common parameter includes a name-recognition parameter determined based on a name recognition of the target software, the resource information further indicates the name recognition of software, and the processor is configured to determine the name-recognition parameter by referring to the resource information. Accordingly, a vulnerability threat of the evaluation target can be evaluated by taking into consideration the name recognition of the target software of the vulnerability.

### Item 7

In the vulnerability threat evaluation system according to the item described above, the storage apparatus is configured to further store in advance design information that is information related to a design of the evaluation target, and the processor is configured to calculate, based on the design information and the vulnerability information, a relevance parameter indicating a similarity between the evaluation target and the target software as the common parameter. Accordingly, a vulnerability threat of the evaluation target can be evaluated by taking into consideration a degree of relevance between the target software and the evaluation target based on the similarity between the target software and the evaluation target.

### Item 8

In the vulnerability threat evaluation system according to the item described above, the processor is configured to represent the vulnerability information as a first vector, represent the design information as a second vector, and calculate the similarity based on a distance between the first vector and the second vector.

### Item 9

In the vulnerability threat evaluation system according to the item described above, the processor is configured to notify information related to a vulnerability threat of an evaluation target of which the threat level is equal to or higher than a predetermined threshold to a user of the evaluation target.

### Item 10

In the vulnerability threat evaluation system according to the item described above, the processor is configured to display information related to a vulnerability threat of the evaluation target based on the threat level of the evaluation target.

### Item 11

In the vulnerability threat evaluation system according to the item described above, the processor is configured to calculate a weighted sum of the security parameter and the common parameter as the threat level.

### Item 12

A vulnerability threat evaluation method for a computer equipped with a storage apparatus and a processor to evaluate a threat posed by a vulnerability of an evaluation target constituted of resources and software, the vulnerability threat evaluation method including: the storage apparatus storing, in advance: resource information indicating resources where software exists in the evaluation target; and security information indicating information related to restrictions on access to resources in the evaluation target, and the processor: acquiring vulnerability information that is information regarding a vulnerability present in software; based on the vulnerability information and the resource information, specifying target software having a vulnerability and a target resource in which the target software is present in the evaluation target; based on information of the target resource and the security information, calculating a security parameter that is a parameter specific to the evaluation target and determined according to the restrictions on access to the target resource in the evaluation target; based on information of the target software, calculating a common parameter indicating a degree to which a threat posed by a vulnerability affects the evaluation target independent of the evaluation target; and based on the security parameter and the common parameter, calculating a threat level indicating a severity of a threat posed by a vulnerability of the evaluation target.

### Item 13

A vulnerability threat evaluation program that causes a computer equipped with a storage apparatus and a processor to evaluate a threat posed by a vulnerability of an evaluation target constituted of resources and software, the vulnerability threat evaluation program causing the storage apparatus to store, in advance: resource information indicating resources where software exists in the evaluation target; and security information indicating information related to restrictions on access to resources in the evaluation target, and causing the processor to: acquire vulnerability information that is information regarding a vulnerability present in software; based on the vulnerability information and the resource information, specify target software having a vulnerability and a target resource in which the target software is present in the evaluation target; based on information of the target resource and the security information, calculate a security parameter that is a parameter specific to the evaluation target and determined according to the restrictions on access to the target resource in the evaluation target; based on information of the target software, calculate a common parameter indicating a degree to which a threat posed by a vulnerability affects the evaluation target independent of the evaluation target; and based on the security parameter and the common parameter, calculate a threat level indicating a severity of a threat posed by a vulnerability of the evaluation target.

What is claimed is:

1. A vulnerability threat evaluation system that evaluates a threat posed by a vulnerability of an evaluation target constituted of resources and software,
the vulnerability threat evaluation system comprising: a storage apparatus and a processor, wherein
the storage apparatus is configured to store, in advance: resource information indicating resources where software exists in the evaluation target; and
security information indicating information related to restrictions on access to resources in the evaluation target, and
the processor is configured to:
acquire vulnerability information that is information regarding a vulnerability present in software;
based on the vulnerability information and the resource information, specify target software having a vulnerability and a target resource in which the target software is present in the evaluation target;
based on information of the target resource and the security information, calculate a security parameter that is a parameter specific to the evaluation target and determined according to the restrictions on access to the target resource in the evaluation target;
based on information of the target software, calculate a common parameter indicating a degree to which a threat posed by a vulnerability affects the evaluation target independent of the evaluation target; and
based on the security parameter and the common parameter, calculate a threat level indicating a severity of a threat posed by a vulnerability of the evaluation target.

2. The vulnerability threat evaluation system according to claim 1, wherein
the evaluation target is an infrastructure of an information system.

3. The vulnerability threat evaluation system according to claim 1, wherein
the storage apparatus is configured to further store in advance user information that is information related to a user of the evaluation target, and
the processor is configured to:
calculate, based on the user information, a user parameter which is a parameter specific to the evaluation target and which is determined according to the user of the evaluation target, and
calculate the threat level based on the security parameter, the common parameter, and the user parameter.

4. The vulnerability threat evaluation system according to claim 1, wherein
the storage apparatus is configured to store in advance network information indicating a connection configuration of resources in the evaluation target, and
the processor is configured to:
calculate, based on the network information, a network parameter which is a parameter specific to the evaluation target and which is determined for the target resource according to the connection configuration of resources in the evaluation target; and
calculate the threat level based on the security parameter, the common parameter, and the network parameter.

5. The vulnerability threat evaluation system according to claim 4, wherein
the processor is configured to determine the network parameter based on a depth corresponding to the number of resources traversed by data communication from outside the evaluation target before reaching the target resource.

6. The vulnerability threat evaluation system according to claim 1, wherein
the common parameter includes a name-recognition parameter determined based on a name recognition of the target software,
the resource information further indicates the name recognition of software, and
the processor is configured to determine the name-recognition parameter by referring to the resource information.

7. The vulnerability threat evaluation system according to claim 1, wherein
the storage apparatus is configured to further store in advance design information that is information related to a design of the evaluation target, and
the processor is configured to:
calculate, based on the design information and the vulnerability information, a relevance parameter indicating a similarity between the evaluation target and the target software as the common parameter.

8. The vulnerability threat evaluation system according to claim 7, wherein
the processor is configured to
represent the vulnerability information as a first vector, represent the design information as a second vector, and calculate the similarity based on a distance between the first vector and the second vector.

9. The vulnerability threat evaluation system according to claim 1, wherein
the processor is configured to notify information related to a vulnerability threat of an evaluation target of which the threat level is equal to or higher than a predetermined threshold to a user of the evaluation target.

10. The vulnerability threat evaluation system according to claim 1, wherein
the processor is configured to display information related to a vulnerability threat of the evaluation target based on the threat level of the evaluation target.

11. The vulnerability threat evaluation system according to claim 1, wherein
the processor is configured to calculate a weighted sum of the security parameter and the common parameter as the threat level.

12. A vulnerability threat evaluation method for a computer equipped with a storage apparatus and a processor to evaluate a threat posed by a vulnerability of an evaluation target constituted of resources and software, the vulnerability threat evaluation method comprising:
the storage apparatus storing, in advance:
resource information indicating resources where software exists in the evaluation target; and
security information indicating information related to restrictions on access to resources in the evaluation target, and
the processor:
acquiring vulnerability information that is information regarding a vulnerability present in software;
based on the vulnerability information and the resource information, specifying target software having a vulnerability and a target resource in which the target software is present in the evaluation target;
based on information of the target resource and the security information, calculating a security parameter that is a parameter specific to the evaluation target and determined according to the restrictions on access to the target resource in the evaluation target;
based on information of the target software, calculating a common parameter indicating a degree to which a threat posed by a vulnerability affects the evaluation target independent of the evaluation target; and
based on the security parameter and the common parameter, calculating a threat level indicating a severity of a threat posed by a vulnerability of the evaluation target.

13. A non-transitory computer-readable medium containing a vulnerability threat evaluation program that causes a computer equipped with a storage apparatus and a processor to evaluate a threat posed by a vulnerability of an evaluation target constituted of resources and software, the vulnerability threat evaluation program:
causing the storage apparatus to store, in advance:
resource information indicating resources where software exists in the evaluation target; and
security information indicating information related to restrictions on access to resources in the evaluation target; and
causing the processor to:
acquire vulnerability information that is information regarding a vulnerability present in software;
based on the vulnerability information and the resource information, specify target software having a vulnerability and a target resource in which the target software is present in the evaluation target;
based on information of the target resource and the security information, calculate a security parameter that is a parameter specific to the evaluation target and determined according to the restrictions on access to the target resource in the evaluation target;
based on information of the target software, calculate a common parameter indicating a degree to which a threat posed by a vulnerability affects the evaluation target independent of the evaluation target; and
based on the security parameter and the common parameter, calculate a threat level indicating a severity of a threat posed by a vulnerability of the evaluation target.
